(19) United States
(12) Patent Application Publication
(10) Pub. No.: US 2023/0247990 A1
(43) Pub. Date: Aug. 10, 2023

(54) Stable Botanical Antimicrobial Compositions

(71) Applicant: The Trustees of Columbia University in the city of New York, New York (US)

(72) Inventors: Shanta S Modak, River Edge, NJ (US); Chathuranga C De Silva, Cliffside Park, NJ (US); Nayana Baiju, Kochi (IN)

(21) Appl. No.: 18/014,334

(22) PCT Filed: Jul. 2, 2021
(86) PCT No.: PCT/US21/40270

§ 371 Date: Jan. 3, 2023

Related U.S. Application Data
(60) Provisional application No. 63/047,505, filed on Jul. 2, 2020.

(51) Int. Cl. A01N 37/06; C11D 3/48; A01P 1/00; A01N 25/02

(52) U.S. Cl. CPC A01N 37/06; C11D 3/48; A01P 1/00; A01N 25/02

(57) ABSTRACT

The present technology relates to stable antimicrobial compositions comprising a combination of undecylenic acid and one or more organic acids or salts thereof, which can be useful for sanitizing laundry and fabrics. These botanical compositions can still achieve antimicrobial efficacy and keep bacteria counts low while exhibiting exceptional stability. The present technology also relates to methods of disinfecting laundry or fabrics, comprising contacting such compositions to the laundry or fabrics, including adding any of the compositions to a washing machine or automatic laundering machine.

### CROSS-REFERENCE TO RELATED APPLICATIONS

This application is an International (PCT) Application and claims priority to U.S. Provisional Application No. 63/047,505, filed on Jul. 2, 2020, the disclosure of which is hereby incorporated by reference in its entirety.

### BACKGROUND

The present technology relates to antimicrobial compositions, particularly those suitable for disinfecting laundry and fabrics.

Microbes live in every part of the biosphere including air, water, and soil. Pathogenic microbes can cause infection and other complications in public, hospital, institutional, business and home settings. Although not all microbes are pathogenic, many microbes produce by-products that are aesthetically displeasing, such as foul odors and discoloration.

Researchers have identified textiles as a possible source of patient infections. Protocols for infection prevention in most hospitals in the United States generally necessitate the use of disposable garments; however, this practice is becoming increasingly unsustainable since many disposable garments are not biodegradable, and they need to be disposed of in landfills. Laundries associated with healthcare facilities have an ongoing need to ensure that the cleaned linen is free of microbes. It would be useful if the benefits of disposable garments could be provided without the added burden of high disposal costs.

Furthermore, when it comes to certain laundry loads that may require extra care such as children's clothes, bedding, towels, hospital gowns or sportswear, the detergent typically used often does not completely eliminate bacteria that can cause illnesses and create lingering bad odors. This is of particular concern when small amounts of detergent and cold water are used for washing.

Therefore, an ongoing need exists for antimicrobial (including disinfecting or sanitizing) compositions that are useful for laundry applications, fast acting and effective that can adequately sanitize laundry, that contain natural, non-irritating ingredients, and that exhibit prolonged stability.

### SUMMARY

In certain embodiments, the present technology is directed to an antimicrobial composition comprising:

(a) 1 to 7% w/w undecylenic acid;

(b) 1 to 20% w/w organic acid or salt thereof; wherein the organic acid is citric acid, lactic acid, benzoic acid, sorbic acid, salicylic acid, or any combination thereof; and

(c) 10 to 40% w/w ethanol or denatured alcohol.

In certain embodiments, the present technology is directed to an antimicrobial composition comprising:

(a) 1 to 3% w/w undecylenic acid;

(b) 12 to 18% w/w citric acid;

(c) 20 to 40% w/w alcohol;

(d) 1 to 5% w/w benzoic acid;

(e) 1 to 3% w/w sodium citrate;

(f) 2 to 4% w/w sodium dodecyl sulfate; and

(g) 40 to 60% w/w water.

In certain embodiments, the present technology is directed to an antimicrobial composition comprising:

(a) 1 to 3% w/w undecylenic acid;

(b) 12 to 18% w/w citric acid;

(c) 10 to 40% w/w alcohol;

(d) 1 to 5% w/w benzoic acid;

(e) 1 to 3% w/w sodium citrate;

(f) 2 to 4% w/w sodium dodecyl sulfate;

(g) 0.3 to 1% w/w octanediol;

(h) 5 to 10% w/w co-solvent selected from: (i) propyleneglycol, (ii) 1,3 propanediol, or any combination thereof; and

(i) 40 to 60% w/w water.

In certain embodiments, the present technology is directed to an antimicrobial composition comprising:

(a) 1 to 3% w/w undecylenic acid;

(b) 12 to 18% w/w citric acid;

(c) 10 to 40% w/w alcohol;

(d) 1 to 5% w/w benzoic acid;

(e) 1 to 3% w/w sodium citrate;

(f) 5 to 10% w/w sodium dodecyl sulfate; and

(g) 40 to 60% w/w water.

In certain embodiments, the present technology is directed to an antimicrobial composition comprising:

(a) 3 to 6% w/w undecylenic acid;

(b) 20 to 32% w/w citric acid;

(c) 45 to 60% w/w alcohol;

(d) 3 to 10% w/w benzoic acid;

(e) 2 to 8% w/w sodium citrate;

(f) 2 to 6% w/w sodium dodecyl sulfate; and

(g) 1 to 15% w/w water.

In certain embodiments, the present technology is directed to methods of sanitizing or disinfecting laundry or a fabric, comprising contacting a composition herein with the laundry or fabric.

### DETAILED DESCRIPTION

All ingredient and formulation percentages are by weight (w/w), unless explicitly noted in specific formulations. All ingredients are at 100% purity/concentration unless otherwise noted.

As used herein, “sanitizing” or “sanitizer” are used interchangeably and refer to the preservation of health by removing, preventing, neutralizing, or controlling any agent that injures the health, such as a microbe.

As used herein, “disinfecting” or “disinfectant” are used interchangeably and refer to the destruction or inhibition of growth or effect of any biological agent or contaminant, such as a microbe. Generally, disinfectants are used primarily for surfaces.

As used herein, “antimicrobial” or “antimicrobial agent” means an agent that kills microorganisms or stops their growth. These include, but are not limited to, antibacterial agents, antifungal agents, antiviral agents, microbiocidal agents, antibiotics, bactericidal agents, bacteriostatic agents, disinfectants, sanitizers, and antiseptics. Generally, antiseptics are used primarily for living tissue and skin.

In certain embodiments, the compositions herein are stable. As used herein, “stable” means exhibiting efficacy after more than 1 year. As used herein, “exhibiting efficacy” means showing more than 4.0 log₁₀ reduction in bacterial growth from that of control in the EN1276 test, when challenged with 5×10⁸ CFU of bacteria, within 5 minutes of contact. In certain embodiments, the 1 year period is achieved through simulating such conditions with the accelerated aging method. The accelerated aging method can be conducted by keeping the solutions at 45° C. for 8 weeks, which is equivalent to stability of 1 year under regular, room temperature conditions.

In certain embodiments, a composition herein can include an antimicrobial composition having long term stability and completely or substantially all natural ingredients, including botanical ingredients. For example, a composition herein can be a completely or substantially completely natural laundry disinfecting or sanitizing composition.

In certain embodiments, a composition herein comprises an antibacterial agent, wherein the antibacterial agent is undecylenic acid.

In certain embodiments, a composition herein comprises: (a) 1 to 7% w/w undecylenic acid; and (b) 1 to 20% w/w organic acids or salts thereof selected from citric acid, lactic acid, benzoic acid, sorbic acid, salicylic acid, and combinations thereof.

In certain embodiments, a composition herein further comprises 10 to 40% w/w or 30 to 40% w/w ethanol (for example, denatured ethanol) and water.

In various embodiments, a composition herein can further comprise 0.5 to 5% w/w of one or more surfactants; for example, sodium dodecyl sulfate or potassium dodecyl sulfate; as well as one or more nonionic surfactants, e.g., cocoamidopropyl betaine, a fatty acid ester of sorbitol, sorbitan, or polyoxyethylene sorbitan; or any combination thereof. In various embodiments, a composition herein can further comprise one or more chelating agents; for example, sodium ethylenediaminetetraacetic acid (EDTA), sodium phytate or any combination thereof; in amounts of 0.05 to 1% w/w in certain embodiments.

In certain embodiments, a composition herein can further comprise a solubility enhancing agent, for example, one or more selected from pentylene glycol, octanediol, decanediol, 1,3 propanediol, propylene glycol, glycerin, benzyl alcohol, phenoxyethanol, phenyl ethanol, isopropanol, or any combination thereof. In various embodiments, these can be any of the following: 0.1 to 2% w/w pentylene glycol; 0.1 to 2% w/w octanediol; 0.1 to 2% w/w decanediol; 5 to 30% w/w 1,3-propanediol; 3 to 10% w/w propylene glycol; or 1 to 10% w/w glycerin, benzyl alcohol, phenoxyethanol, or any combination thereof.

In certain embodiments, a composition herein further comprises 0.01 to 5% w/w of one or more essential oils; in various embodiments, this can be lemongrass oil, lemon oil, orange oil, cinnamon oil, cedarwood oil, myrrh oil, geranium oil, bergamot oil, thymol, farnesol, or any combination thereof. In certain embodiments, a composition herein can further comprise thymol.

In certain embodiments, a composition herein can be diluted with water; for example, in any ratio of composition to water; or a ratio of 1:10 to 1:1200, or 1:50 to 1:300, or 1:100 to 1:200, or 1:200 ratio of the composition to water.

As discussed herein, one advantage of the compositions herein is their suitability for contact with fabrics and other items that are typically washed as laundry—that is, laundered, either by hand or in machines. As used herein, “laundry” means any material that can be laundered, including but not limited to clothing and items worn on any part of the body and other household fabrics (for example, rugs, tablecloths, curtains, bedding, towels, and protective materials and garments such as face masks and head coverings). In certain embodiments, the compositions herein are useful as laundry sanitizers. Laundry sanitizers (also referred to herein as laundry sanitizing compositions) are typically used in conjunction with detergents in order to kill bacteria and other microbes that may be present on laundry and fabrics, and that laundry detergents typically cannot kill.

In certain embodiments, such compositions herein can be used at the same time as a detergent during the washing cycle (e.g., the washing cycle of a washing machine or automatic laundering machine)—that is, they can be added at the same stage of the wash cycle as the detergent—for example, at the beginning of the cycle, contemporaneous with the loading of the laundry into the machine and the adding of the detergent to the machine or in direct contact with the laundry. In certain embodiments, a composition herein can be applied before or after the washing cycle (for example, in a rinse cycle, e.g., the rinse cycle of a washing machine or automatic laundering machine).

As used herein, “washing machine” means any mechanical apparatus configured to wash laundry; and “automatic laundering machine” means any washing machine that is configured to wash laundry automatically once started, and takes the laundry through a sequence of timed steps from dirty to laundered. When used in an automatic laundering machine, the compositions herein can, in various embodiments, be added in a laundry detergent composition compartment in the automatic laundering machine and released during a main wash cycle, or contacted directly with the laundry before the main wash cycle begins (e.g., by pouring directly onto the laundry in the automatic laundering machine, either as a preliminary step to the main wash cycle or a pre-treatment step).

Thus, in certain embodiments, the present technology is directed to methods for disinfecting laundry or fabrics, comprising adding any of the compositions herein to a washing machine or automatic laundering machine. In various embodiments, an exemplary composition can be added during a wash cycle or a rinse cycle; or can be added in a laundry detergent composition compartment and released during a main wash cycle.

In certain embodiments, the products herein can significantly reduce bacteria counts in as little as five minutes of contact with bacteria before, during or after a detergent wash. Furthermore, in certain embodiments, the compositions herein are at least partly or entirely biodegradable.

In certain embodiments, a composition herein comprises the following: 1 to 3% w/w undecylenic acid; 12 to 18% w/w citric acid; 20 to 40% w/w alcohol; 1 to 5% w/w benzoic acid; 1 to 3% w/w sodium citrate; 2 to 4% w/w sodium dodecyl sulfate; and 40 to 60% w/w water.

In certain embodiments, a composition herein comprises the following: 1 to 3% w/w undecylenic acid; 12 to 18% w/w citric acid; 10 to 40% w/w alcohol; 1 to 5% w/w benzoic acid; 1 to 3% w/w sodium citrate; 5 to 10% w/w propylene glycol; 2 to 4% w/w sodium dodecyl sulfate; and 40 to 60% w/w water.

In various embodiments, a composition herein comprises 2 to 4% w/w or 5 to 10% w/w or 2 to 10% w/w or 2 to 6% w/w of any of the following surfactants or chelating agents: sodium dodecyl sulfate, sodium dodecyl sulfate, potassium dodecyl sulfate, disodium EDTA, or any combination thereof.

As used herein, “essentially free of” an ingredient means containing less than 5% w/w of such ingredient. As used herein, “completely free of” an ingredient means containing none of that ingredient. In various embodiments, the compositions herein contain less than 5% w/w, less than 2% w/w, or less than 1% w/w or 0% w/w of non-plant derived sanitizing agents, including those commonly used sanitizing agents mentioned herein.

In certain embodiments, the compositions herein are essentially free of, or completely free of, any synthetic sanitizing agents. As used herein, “synthetic sanitizing agent,” “synthetic sanitizer,” “synthetic antimicrobial” or “synthetic antibacterial” all mean a sanitizing, antimicrobial or antibacterial agent derived from non-natural ingredients, including petroleum products. In certain embodiments, such non-botanical or synthetic sanitizing or antimicrobial agents can include any of the following ingredients: quaternary ammonium compounds (QAC), phenolics (Triclosan®, Parachlorometaxylenol (PCMX)), harsh chemicals such as sodium hypochlorite (bleach), sodium hydroxide, and compounds containing ammonia, chlorine, or perchloroethylene, all of which are well-known irritants.

In certain embodiments, the compositions herein, when subject to high dilution (that is, at least 170 to 175 fold dilution which occurs in the typical rinse cycle in a standard clothes washing machine) still achieve antimicrobial efficacy and keep bacteria counts low during EN1276 method SOP M/V 080/8 (the European Standard for evaluation of bactericidal efficacy of disinfecting liquids) testing in both clean and dirty conditions. Standard tests were conducted under dirty condition in accordance with the EN1276 method with inoculum concentration of 5×10⁸ CFU/mL. The test sample (or blend) was diluted to 1:173 with EN Hard Water prior to all testing. The tests were carried out with a 5 minute contact time and appropriate neutralization steps in accordance with EN1276 method. Results were reported as log₁₀ reduction from control calculated as follows: average control growth (7.7 log₁₀); 0-14 CFU/plate test growth (2.15 log₁₀); >15 CFU/plate test growth (log growth calculated with appropriate dilution and reported as is). Maximum allowable log₁₀ reduction is 5.6 log₁₀.

For example, in certain embodiments, a composition herein can achieve at least 5.0 log₁₀ reduction in bacterial growth from that of control when challenged with 5×10⁸ CFU of bacteria during, or within (up to) 5 minutes of contact.

Another aspect of certain embodiments of the present technology is the addition of one or more solvents, including but not limited to: ethanol, benzyl alcohol (commonly found in fruits and teas and also found in a variety of essential oils, including jasmine and hyacinth), phenoxyethanol (derived from grapefruit), or 1,3-propanediol (for example, that derived from corn sugar and available under the trade name Zemea® from Dupont and Lyle Bioproducts, Loudon, Tenn., USA). In certain embodiments, the one or more solvents are included in amounts of 30 to 60% w/w of the compositions herein, and can serve to enhance the antimicrobial efficacy. In certain embodiments, the compositions herein can achieve more than 5.0 log₁₀ reduction in bacterial growth from that of control when challenged with 5×10⁸ CFU of bacteria during, or within (up to) 5 minutes of contact.

In certain embodiments, the compositions herein can be specially formulated to kill bacteria that are left after the detergent wash in the case of laundry sanitizing applications, or that kill bacteria before or during the detergent wash that are known laundry detergents cannot kill.

In certain embodiments, the compositions herein are completely or substantially completely natural—that is, they are completely or substantially derived from naturally-occurring sources, rather than synthetic sources. In certain embodiments, the technology herein is directed to compositions that include sanitizers that are botanical. As used herein, “botanical” means obtained from a plant. Thus, in certain embodiments, the compositions herein mainly contain ingredients sourced from plants; and when referring herein to “botanical antimicrobial compositions” it is meant that such compositions contain one or more botanical ingredients.

As used herein, “essentially botanical” means at least 95% w/w from botanical sources. In certain embodiments, the compositions herein include sanitizing agents that are essentially botanical. In certain embodiments, the compositions herein are essentially free of, or completely free of, non-botanical sanitizing agents. As used herein, “non-botanical” means not derived from plants.

As used herein, “essential oil” (EO) is a volatile oil obtained from a plant or an animal source that comprises one or more active agent (also referred to herein as an Isolated Component or “IC” or “constituent” or “ingredient”) which may be, for example but not by way of limitation, a monoterpene or sesquiterpene hydrocarbon, alcohol, ester, ether, aldehyde, ketone, or oxide. Essential oils are commonly extracted by distillation, expression, extraction, resin tapping, wax embedding or cold pressing. Isolated components generally fall into the following categories: acids, alcohols (e.g., monoterpenols or sesquiterpenols), aldehydes, coumarins, esters, ketones, lactones, terpenes (e.g., monoterpenes or sesquiterpenes), oxides, or phenols.

As used herein, “botanical extract” means a composition from a plant source (a botanical) that is prepared by soaking the botanical in a solvent (such as water or alcohol). A botanical extract refers to the resultant liquid, which contains the essential oil with the solvent. As used herein, “extract” generally means any composition prepared in this manner, whether or not it is from a botanical source.

For example, “thyme oil” refers to essential oil produced through methods such as steam distillation of the leaves and flowers of the thyme plant. Thyme oil contains organic compounds such as p-cymene, myrcene, borneol, carvacrol, linalool and thymol. Thyme oil generally contains 20 to 54% w/w thymol. When “thymol/thyme oil” is mentioned here, this refers generally to any materials derived from the thyme plant, and can mean either thymol, thyme oil, or a combination of both.

### Undecylenic Acid

In various embodiments, antimicrobial compositions herein comprise undecylenic acid. Undecylenic acid is an unsaturated fatty acid typically used as an antifungal on the skin. Although the antimicrobial activity of undecylenic acid was previously known to be “restricted to the inhibition of moulds including pathogenic fungi” (W. Paulus, Microbicides for the Protection of Materials: A Handbook, p. 209), the present embodiments are directed to the surprising finding that undecylenic acid and organic acid together demonstrate synergistic efficacy in killing bacteria. In various embodiments, an antimicrobial composition herein comprises 1 to 7% w/w or 3 to 6% w/w undecylenic acid.

In certain embodiments, the compositions herein exhibit prolonged stability by employing specific solvent mixtures in the formulations. In certain embodiments, the present technology is directed to laundry sanitizer compositions comprising undecylenic acid, organic acid and or a salt thereof, ethanol; and in certain embodiments can further comprise any of the following: alkanediol (e.g., 1,3-propanediol and octanediol), propylene glycol, or sodium dodecyl sulfate.

Certain useful and desirable properties of the compositions herein can be illustrated in the following Examples.

### EXAMPLE 1

### Evaluation of Synergistic Antimicrobial Efficacy of Undecylenic Acid and Organic Acid

Synergistic antimicrobial efficacy of undecylenic acid with organic acid was achieved (see Table 1).

The concentrations of the ingredients are expressed as percentage w/w. Antimicrobial efficacy of the formulations listed in Table 1 was tested using the EN1276 method, which is a quantitative suspension test for the valuation of bactericidal activity of chemical disinfectants. The test sample (or blend) was diluted to 1:173 with EN Hard Water prior to all testing. The tests were conducted at dirty condition (culture media containing 3 g/L of bovine serum albumin) in accordance with the EN1276 method with inoculum concentration of 1.5×10⁸ CFU/mL of S. aureus. The tests were carried out with a 5-minute contact time, followed by appropriate neutralization and dilution steps in accordance with the standard EN1276 method.

TABLE 1
Synergistic antimicrobial efficacy as tested by the EN1276 method

| Ingredient | S0 | S1 | S2a | S2b | S3 | S4 | S5 | S6 |
|---|---|---|---|---|---|---|---|---|
| SDA 40B | 15 | 15 | 15 | 15 | 15 | 15 | 15 | 15 |
| 1,3-propanediol | — | 10 | — | 10 | 10 | 10 | 10 | 10 |
| SDS | 2 | 2 | 2 | 2 | 2 | 2 | 2 | 2 |
| Lactic acid | — | 7 | 7 | 7 | 7 | 7 | 7 | 7 |
| Citric acid | — | 3 | — | — | 3 | 3 | 3 | 3 |
| Benzoic acid | — | 2 | — | — | 2 | 2 | 2 | 2 |
| Octanediol | — | — | — | — | — | 1 | 1 | 1 |
| Undecylenic acid | 3 | — | 3 | 3 | 3 | 3 | 3 | 3 |
| Thymol | — | — | — | | — | — | 3 | — |
| Phenoxyethanol | — | — | — | | — | — | | 2.5 |
| Benzyl alcohol | — | — | — | | — | — | | 2.5 |
| Water (qs to 100) | 80 | 61 | 73 | 63 | 58 | 57 | 54 | 52 |
| Log₁₀ Reduction | 0.5 | 0.5 | 1.5 | 2.2 | 3.29 | 4 | 5 | 4.52 |

These test results revealed that combining undecylenic acid with organic acids, in the presence of certain solvent mixtures (e.g., alcohol (Specially Denatured Alcohol (SDA) 40B) and 1,3-propanediol (Zemea® Propanediol), synergistically enhanced antimicrobial efficacy as shown by a log reduction of 3.29 (Formulation S3), although neither undecylenic acid and solvent (Formulation S0) nor organic acids and solvents (Formulation Si) had any antimicrobial efficacy as shown by a log reduction of 0.5. Adding octanediol to the combination of undecylenic acid and organic acids enhanced its antimicrobial efficacy (Formulation S3 v. Formulation S4), which could be further enhanced by including thymol (Formulation S4 v. Formulation S5).

In certain embodiments, an antimicrobial composition herein comprises 0.01 to 5% w/w undecylenic acid and 0.1 to 20% w/w organic acid or salt thereof. In certain embodiments, the organic acid or salt thereof is: benzoic acid, citric acid, lactic acid, salicylic acid, or any combination thereof.

In certain embodiments, the composition of the present invention further comprises any of the following:

(a) alkanediol; e.g., 1,3-propanediol, propylene glycol, pentylene glycol, octanediol, decanediol, or any combination thereof;

(b) 0.005 to 5% w/w essential oil; e.g., thymol, lemongrass oil, lemon oil, orange oil, cinnamon oil, cedarwood oil, myrrh oil, geranium oil, bergamot oil, or any combination thereof;

(c) 0.01 to 5% w/w surfactant or chelating agent; e.g., sodium dodecyl sulfate; or

(d) 0.01 to 50% w/w emollient or solvent; e.g., glycerin, propylene glycol, benzyl alcohol, phenoxyethanol, phenyl ethanol, ethyl alcohol, isopropanol, or any combination thereof.

In certain embodiments, the alkanediol is 1,3-propanediol present at a concentration of 1 to 20% w/w, or propylene glycol present at a concentration of 3 to 10% w/w, or pentylene glycol, or octanediol, or decanediol present at a concentration of 0.005 to 2% w/w, or any combination thereof. In certain embodiments, the essential oil is present at a concentration of 0.005 to 1% w/w.

### EXAMPLE 2

### Laundry Sanitizer Formulations Containing Thymol and Undecylenic Acid

The contributing effects of each of the following ingredients to combinations of thymol and undecylenic acid in sanitizer formulations was investigated:

1. Lactic acid

2. Citric Acid

3. Benzoic acid

4. Salicylic acid

5. Benzyl alcohol

6. Phenoxyethanol

7 Octanediol

8. 1,3-propanediol

Concentrations are expressed in percentage w/w. The test method and protocol were the same as those in Example 1—namely, tests were carried out in dirty condition at 1:173 dilution in accordance with the EN1276 method and used S. aureus as the test organism. Results are shown below.

TABLE 2A
Citric acid enhances the efficacy of formulations containing 3%
w/w thymol and 3% w/w undecylenic acid.

| Ingredient | CRB-F2A | CRB-81F |
|---|---|---|
| Thymol | 3 | 3 |
| Lactic Acid | 7 | 7 |
| Specially Denatured Alcohol | 15 | 15 |
| 200 proof (SDA 40B) | | |
| 1,3-propanediol | 10 | 10 |
| Undecylenic acid | 3 | 3 |
| Citric acid | — | 5 |
| Octanediol | 1 | 1 |
| Sodium Lauryl Sulfate | 3 | 3 |
| Water (qs to 100) | 58 | 53 |
| Log₁₀ Reduction | 4.1 | 5.5 |

TABLE 2B
Citric acid enhances the efficacy of formulations containing 1%
w/w thymol and 3% w/w undecylenic acid

| Ingredient | CRB-83L | CRB-83L-4 |
|---|---|---|
| Thymol | 1 | 1 |
| Lactic acid | 7 | 7 |
| SDA 40B | 15 | 15 |
| 1,3-propanediol | 10 | 10 |
| Undecylenic acid | 3 | 3 |
| Citric acid | 5 | — |
| Octanediol | 1 | 1 |
| Benzoic acid | 2 | 2 |
| SDS | 3 | 3 |
| Water (qs to 100) | 53 | 58 |
| Log₁₀ Reduction | 4 | 3.3 |

TABLE 2C
Combinations of citric acid, benzoic acid and salicylic acid
enhance the efficacy of formulation containing 3% w/w thymol
and 3% w/w undecylenic acid.

| Ingredient | CRB-82G | CRB-82F | CRB-82G-3 | CRB-S8 |
|---|---|---|---|---|
| Thymol | 3 | 3 | 3 | 3 |
| Lactic Acid | 7 | 7 | 7 | 7 |
| SDA 40B | 10 | 10 | 10 | 10 |
| 1,3-propanediol | 7 | 7 | 7 | 7 |
| Undecylenic acid | 3 | 3 | 3 | 3 |
| Citric acid | 5 | 5 | 5 | — |
| Benzoic acid | 2 | — | 2 | — |
| Salicylic acid | — | 2 | 2 | — |
| Sodium Lauryl Sulfate | 3 | 3 | 3 | 3 |
| Water (qs to 100) | 59 | 59 | 57 | 67 |
| Log₁₀ Reduction | 5.18 | 5.22 | 5.6 | 4.1 |

TABLE 3
Increasing undecylenic acid concentration results in
increased antimicrobial efficacy in laundry sanitizer
formulations containing thymol, citric acid,
benzoic acid, benzyl alcohol and phenoxyethanol.

| | CRB- | CRB- | CRB- | CRB- | CRB- |
|---|---|---|---|---|---|
| Ingredient | 83D | 91 | 91B | 92 | 81A |
| Thymol | 3 | 3 | 3 | 3 | 3 |
| Lactic Acid | 7 | 7 | 7 | 7 | 7 |
| SDA 40B | 15 | 15 | 15 | 15 | 15 |
| 1,3-propanediol | 10 | 10 | 10 | 10 | 10 |
| Undecylenic acid | — | 1 | 2 | 3 | 4 |
| Citric acid | 5 | 5 | 5 | 5 | 5 |
| Benzoic acid | 1 | 1 | 1 | 1 | 1 |
| Sodium Lauryl | 3 | 3 | 3 | 3 | 3 |
| Sulfate | | | | | |
| Phenoxyethanol | 2.5 | 2.5 | 2.5 | 2.5 | 2.5 |
| Benzyl Alcohol | 2.5 | 2.5 | 2.5 | 2.5 | 2.5 |
| Water (qs to 100) | 50 | 49 | 49 | 45 | 45 |
| Log₁₀ Reduction | 2 | 2.9 | 4.17 | 4.55 | 5.6 |

Table 3

TABLE 4
Increasing thymol concentration results in increased antimicrobial
efficacy in laundry sanitizer formulations containing 3% w/w undecylenic
acid without citric acid and benzoic acid.

| Ingredient | CRB-F13 | CRB-83I | CRB-81B | CRB-S8 |
|---|---|---|---|---|
| Thymol | — | 1 | 2 | 3 |
| Lactic Acid | 7 | 7 | 7 | 7 |
| SDA 40B | 10 | 10 | 10 | 10 |
| 1,3-propanediol | 7 | 7 | 7 | 7 |
| Undecylenic acid | 3 | 3 | 3 | 3 |
| Octanediol | 1 | 1 | 1 | — |
| Sodium Lauryl | 3 | 3 | 3 | 3 |
| Sulfate | | | | |
| Water (qs to 100) | 70 | 69 | 67 | 66 |
| Log₁₀ Reduction | 2.5 | 2.9 | 3.8 | 4.1 |

TABLE 4A
Formulations containing varying amounts of undecylenic acid and
thymol, in the absence of citric acid and benzoic acid.

| Ingredient | CRB-83J | CRB-83F2 | CRB-83M2 | CRB-83H |
|---|---|---|---|---|
| Thymol | 1 | 1 | 1 | — |
| Lactic Acid | 7 | 7 | 7 | 7 |
| SDA 40B | 10 | 10 | 10 | 10 |
| 1,3-propanediol | 7 | 7 | 7 | 10 |
| Undecylenic acid | 2 | 3 | 4 | 5 |
| Octanediol | 1 | 1 | — | — |
| Sodium Lauryl | 3 | 3 | 3 | 3 |
| Sulfate | | | | |
| Water (qs to 100) | 70 | 69 | 68 | 65 |
| Log₁₀ Reduction | 0.5 | 2.9 | 4 | 4.23 |

TABLE 4B
Formulations containing varying amounts of undecylenic acid and thymol, in the presence
of citric acid and benzoic acid.

| Ingredient | CRB-83D | CRB-83E | CRB-83F | CRB-83G | CRB-83D2 |
|---|---|---|---|---|---|
| Thymol | — | 1 | 1 | 1 | 1 |
| Lactic Acid | 7 | 7 | 7 | 7 | 7 |
| SDA 40B | 10 | 10 | 10 | 10 | 10 |
| 1,3-propanediol | 10 | 10 | 10 | 10 | 10 |
| Undecylenic acid | 5 | 3 | 3 | 2 | 2 |
| Octanediol | 1 | 1 | 1 | — | 2 |
| Citric acid | 5 | 5 | 5 | — | 2 |
| Sodium Lauryl Sulfate | 2 | 2 | 2 | 2 | 2 |
| Benzoic acid | 2 | 2 | — | 2 | 2 |
| Water (qs to 100) | 58 | 59 | 61 | 66 | 62 |
| Log₁₀ Reduction | 5.6 | 5.3 | 4.7 | 1.3 | 2.5 |

TABLE 5
Octanediol enhances antimicrobial efficacy of thymol and
undecylenic acid.

| Ingredient | CRB-83E-2 | CRB-83F-2 |
|---|---|---|
| Thymol | 3 | 3 |
| Lactic Acid | 7 | 7 |
| SDA 40B | 1 | 10 |
| 1,3-propanediol | 10 | 10 |
| Undecylenic acid | 3 | 3 |
| Octanediol | — | 1 |
| Sodium Lauryl Sulfate | 2 | 2 |
| Water (qs to 100) | 67 | 66 |
| Log₁₀ Reduction | 2.21 | 3 |

TABLE 6
1,3-propanediol enhances the antimicrobial efficacy of thymol, lactic
acid, and undecylenic acid

| Ingredient | CRB-82A | CRB-82C | CRB-82E | CRB-81F |
|---|---|---|---|---|
| Thymol | 3 | 3 | 3 | 3 |
| Lactic Acid | 7 | 7 | 7 | 7 |
| SDA 40B | 15 | 10 | — | 15 |
| 1,3-propanediol | — | 5 | 15 | 10 |
| Undecylenic acid | 3 | 3 | 3 | 3 |
| Octanediol | 2 | 2 | 2 | 1 |
| Salicylic acid | 2 | 2 | 2 | — |
| Sodium Lauryl Sulfate | 3 | 3 | 4 | 3 |
| Citric acid | 5 | 5 | 5 | 5 |
| Water (qs to 100) | 60 | 60 | 59 | 53 |
| Log₁₀ Reduction | 4.5 | 4.8 | 5.28 | 5.6 |

TABLE 7
Benzoic acid enhances the efficacy of the laundry sanitizer
composition containing 1% w/w thymol and 3% w/w undecylenic acid

| Ingredient | CRB-83F | CRB-83E |
|---|---|---|
| Thymol | 1 | 1 |
| Lactic acid | 7 | 7 |
| SDA 40B | 10 | 10 |
| 1,3-propanediol | 10 | 10 |
| Undecylenic acid | 3 | 3 |
| Citric acid | 5 | 5 |
| Octanediol | 1 | 1 |
| Benzoic acid | — | 2 |
| SDS | 2 | 2 |
| Water (qs to 100) | 61 | 59 |
| Log₁₀ Reduction | 4.7 | 5.3 |

TABLE 8
Citric acid is more effective in enhancing the efficacy of thymol
and undecylenic acid than lactic acid alone or in combination citric acid.

| Ingredient | CRB-81L-5 | CRB-81L-6 | CRB-81L-7 |
|---|---|---|---|
| Thymol | 1 | 1 | 1 |
| Lactic acid | 12 | 7 | — |
| SDA 40B | 15 | 15 | 15 |
| 1,3-propanediol | 10 | 10 | 10 |
| Undecylenic acid | 3 | 3 | 3 |
| Citric acid | — | 5 | 12 |
| Octanediol | 1 | 1 | 1 |
| SDS | 3 | 3 | 3 |
| Water (qs to 100) | 55 | 55 | 55 |
| Log₁₀ Reduction | 2.4 | 2.7 | 3.1 |

TABLE 9
Citric acid is more effective in enhancing the efficacy of
thymol and undecylenic acid than lactic acid,
which is further enhanced by benzoic acid.

| Ingredient | CRB-81L-8 | CRB-81L-9 | CRB-83L |
|---|---|---|---|
| Thymol | 1 | 1 | 1 |
| Lactic acid | 12 | — | 7 |
| SDA 40B | 15 | 15 | 15 |
| 1,3-propanediol | 10 | 10 | 10 |
| Undecylenic acid | 3 | 3 | 3 |
| Citric acid | — | 12 | 5 |
| Octanediol | 1 | 1 | 1 |
| SDS | 3 | 3 | 3 |
| Benzoic acid | 2 | 2 | 2 |
| Water (qs to 100) | 53 | 53 | 53 |
| Log₁₀ Reduction | 3.3 | 3.6 | 4 |

TABLE 10
Antimicrobial activity of citric acid and undecylenic acid without
thymol

| Ingredient | CRB-81L-11 | CRB-81L-13 | CRB-83L-14 |
|---|---|---|---|
| SDA 40B | 15 | 15 | 15 |
| 1,3-propanediol | 10 | 10 | 10 |
| Undecylenic acid | 3 | 4 | 4 |
| Citric acid | 7 | 7 | 10 |
| Octanediol | 1 | 1 | 1 |
| SDS | 3 | 3 | 3 |
| Benzoic acid | 2 | 2 | 2 |
| Water (qs to 100) | 59 | 58 | 55 |
| Log₁₀ Reduction | 2.5 | 3.5 | 4.3 |

TABLE 11
Laundry sanitizer formulation containing 5% w/w undecylenic acid
is as effective (±0.3 log) as a combination of 3% w/w undecylenic acid and 1% w/w thymol.

| Ingredient | CRB-83D | CRB-83E | CRB-83F | CRB-83G | CRB-83D2 |
|---|---|---|---|---|---|
| Thymol | — | 1 | 1 | 1 | 1 |
| Lactic Acid | 7 | 7 | 7 | 7 | 7 |
| SDA 40B | 10 | 10 | 10 | 10 | 10 |
| 1,3-propanediol | 10 | 10 | 10 | 10 | 10 |
| Undecylenic acid | 5 | 3 | 3 | 2 | 2 |
| Octanediol | 1 | 1 | 1 | — | 2 |
| Citric acid | 5 | 5 | 5 | — | 2 |
| Sodium Lauryl Sulfate | 2 | 2 | 2 | 2 | 2 |
| Benzoic acid | 2 | 2 | — | 2 | 2 |
| Water (qs to 100) | 58 | 59 | 61 | 66 | 62 |
| Log₁₀ Reduction | 5.6 | 5.3 | 4.7 | 1.3 | 2.5 |

TABLE 12
Citric acid shows better antimicrobial efficacy than lactic acid in
presence of thymol/undecylenic acid.

| Ingredient | CRB-84A | CRB-84B | CRB-84C | CRB-84D | CRB-84E |
|---|---|---|---|---|---|
| Thymol | 1 | — | 1 | — | 1 |
| Undecylenic | 3 | 4 | 3 | 4 | 3 |
| acid | | | | | |
| Citric acid | 10 | 10 | — | — | 10 |
| Lactic acid | — | — | 10 | 10 | — |
| Benzoic acid | 2 | 2 | 2 | 2 | — |
| SDA 40B | 15 | 15 | 15 | 15 | 15 |
| 1,3-propanediol | 10 | 10 | 10 | 10 | 10 |
| Octanediol | 1 | 1 | 1 | 1 | 1 |
| SDS | 3 | 3 | 3 | 3 | 3 |
| Water | 55 | 55 | 55 | 55 | 57 |
| (qs to 100) | | | | | |
| Log₁₀ | 4 | 4.5 | 3.3 | 4.4 | 3.7 |
| Reduction | | | | | |

TABLE 13
A laundry sanitizer formulation containing 4% w/w undecylenic acid
alone has higher antimicrobial activity than one containing both 1%
w/w thymol and 3% w/w undecylenic acid, against both gram-positive
bacteria (S. aureus) and gram-negative bacteria (P. aeruginosa).

| Ingredient | CRB-84A | CRB-84B |
|---|---|---|
| Thymol | 1 | — |
| Undecylenic acid | 3 | 4 |
| Citric acid | 10 | 10 |
| Benzoic acid | 2 | 2 |
| SDA 40B | 15 | 15 |
| 1,3-propanediol | 10 | 10 |
| Octanediol | 1 | 1 |
| SDS | 3 | 3 |
| Water (qs to 100) | 55 | 55 |
| Log₁₀ Reduction (S. aureus) | 4 | 4.5 |
| Log₁₀ Reduction (P. aeruginosa) | 5.2 | 5.3 |

As 4% w/w undecylenic acid alone has higher antimicrobial efficacy than the combination of 1% w/w thymol and 3% w/w undecylenic acid. That is thymol can be efficiently replaced with undecylenic acid and therefore we have essentially removed thymol from the formulation for applications where thymol may be not be suitable, which has the added benefit of lowering the cost of the formulation.

### EXAMPLE 3

### Antibacterial Laundry Sanitizer Formulations Having Long Term Stability at 45° C.

As some antibacterial laundry sanitizer formulations were found to be unstable, the formulations herein were further improved to be stable for prolonged periods of time (i.e., more than 1 year tested by the accelerated aging method), as well as effective. The accelerated aging method was conducted by keeping the solutions at 45° C. for 8 weeks, which is equivalent to stability of 1 year at regular, room temperature conditions.

Undecylenic acid, although soluble initially at room temperature in solvents, gradually precipitates when the temperature is higher than 40° C., including the 45° C. temperature used in the accelerated aging method to determine long term stability. One approach to increase the solubility of undecylenic acid increase the amount of alcohol in the composition. However, higher alcohol concentrations may raise concerns about fire safety. Some ingredients such as benzoic acid help in improving the solubility of undecylenic acid by maintaining a lower pH, e.g., pH may work from 1.6-3.

TABLE 14
Laundry sanitizers containing 1.5% w/w undecylenic acid and 20 to 30% w/w alcohol are
stable without solubility enhancing agents such as octanediol and 1,3-propanediol.

| | CRB- | CRB- | CRB- | CRB- | CRB- | CRB- | CRB- | CRB- |
|---|---|---|---|---|---|---|---|---|
| | 86- | 86- | 86- | 86- | 86- | 86- | 86- | 86- |
| Ingredient | CAB29 | CAB30 | CAB31 | CAB32 | CAB33 | CAB34 | CAB35 | CAB36 |
| Undecylenic | 1.5 | 1.5 | 1.5 | 1.5 | 1.5 | 1.5 | 1.5 | 1.5 |
| acid | | | | | | | | |
| Citric acid | 15 | 15 | 15 | 15 | 15 | 15 | 15 | 15 |
| SDA 40B | 20 | 20 | 20 | 25 | 25 | 30 | 30 | 30 |
| Benzoic | 2 | 2 | 2 | 1 | 2 | 2 | 2 | 1 |
| acid | | | | | | | | |
| SDS | 3 | 3 | 3.5 | 3.5 | 3 | 3 | 3 | 3 |
| Octanediol | 0.3 | 0.3 | 0.5 | — | 0.5 | 0.5 | — | — |
| 1,3- | 3 | — | — | — | — | — | — | — |
| Propanediol | | | | | | | | |
| Water | 55.2 | 58.2 | 57.5 | 54 | 53 | 48 | 48.5 | 49.5 |
| (qs to 100) | | | | | | | | |

45° C.

| | | | | | | | | |
|---|---|---|---|---|---|---|---|---|
| 4 weeks | Stable | Stable | Stable | Stable | Stable | Stable | Stable | Stable |
| 8 weeks | Stable | Stable | Stable | Stable | Stable | Stable | Stable | Stable |

Note:
pH of all formulations range from 1.6 to 2.

Table 15: Stability of laundry sanitizers containing 2% w/w undecylenic acid, 15% w/w citric acid and 25 to 30% w/w alcohol.

TABLE 15A

| | CRB- | CRB- | CRB- | CRB- | CRB- | CRB- |
|---|---|---|---|---|---|---|
| | 86- | 86- | 86- | 86- | 86- | 86- |
| | CAB- | CAB- | CAB- | CAB- | CAB- | CAB- |
| Ingredient | 20O | 20Z | 20OZ | 22 | 20A | 20B |
| Undecylenic acid | 2 | 2 | 2 | 2 | 2 | 2 |
| Citric acid | 15 | 15 | 15 | 15 | 15 | 15 |
| SDA 40B | 20 | 20 | 20 | 25 | 30 | 30 |
| Benzoic acid | 2 | 2 | 2 | 2 | 3 | 3 |
| SDS | 3.5 | 3.5 | 3 | 3.5 | 3 | 3 |
| Octanediol | 0.5 | — | 0.5 | — | — | 0.5 |
| 1,3-Propanediol | — | 7 | 7 | — | — | — |
| Water (qs to 100) | 57 | 50.5 | 50.5 | 52.5 | 47 | 46.5 |

45° C.

| | | | | | | |
|---|---|---|---|---|---|---|
| 4 weeks | Stable | Stable | Stable | Stable | Stable | Stable |
| 8 weeks | Stable | Stable | Stable | Stable | Stable | Stable |

Note:
pH of all formulations range from 1.6 to 2.

TABLE 15B

| | CRB | CRB | CRB | CRB | CRB | CRB- |
|---|---|---|---|---|---|---|
| | 86- | 86- | 86- | 86- | 86- | 86- |
| | CAB- | CAB- | CAB- | CAB- | CAB- | CAB- |
| Ingredients | 27 | 27O | 27Z | 27OZ | 38 | 39 |
| Undecylenic | 2 | 2 | 2 | 2 | 2 | 2 |
| acid | | | | | | |
| Citric acid | 15 | 15 | 15 | 15 | 20 | 15 |
| SDA 40B | 30 | 30 | 30 | 30 | 25 | 30 |
| Benzoic acid | 2 | 2 | 2 | 2 | 2 | 2 |
| SDS | 3.5 | 3.5 | 3.5 | 3.5 | 3.5 | 3 |
| Octanediol | — | 0.5 | — | 0.5 | 0.5 | — |
| 1,3-Propanediol | — | — | 5 | 5 | — | — |
| Water | 47.5 | 47 | 42 | 42 | 47 | 48 |
| (qs to 100) | | | | | | |

45° C.

| | | | | | | |
|---|---|---|---|---|---|---|
| 4 week | Stable | Stable | Stable | Stable | Stable | Stable |
| 8 weeks | Stable | Stable | Stable | Stable | Stable | Stable |

Note:
pH of all formulations range from 1.6 to 2.

Solubility of laundry sanitizers containing 2% w/w undecylenic acid, 15% w/w citric acid and low levels of alcohol (25 to 30% w/w) can be achieved by adding (1) 2 to 3% w/w benzoic acid, (2) 3 to 3.5% w/w sodium dodecyl sulfonate (SDS), and (3) 0.5% w/w octanediol or 5 to 7% w/w 1,3-propanediol or both.

TABLE 16
Stability of laundry sanitizers containing 2.5% w/w of undecylenic acid.

| Ingredient | CRB-86-CAB 21O | CRB-86-CAB 37Z | CRB-86-CAB 37OZ | CRB-86-CAB 51A |
|---|---|---|---|---|
| Undecylenic acid | 2.5 | 2.5 | 2.5 | 2.5 |
| Citric acid | 15 | 15 | 15 | 15 |
| SDA 40B | 25 | 30 | 30 | 30 |
| Benzoic acid | 2 | 2 | 2 | 3 |
| SDS | 3.5 | 3 | 3 | 3 |
| Octanediol | 0.5 | — | 0.5 | 0.5 |
| 1,3-Propanediol | — | 7 | 7 | — |
| Water (qs to 100) | 51.5 | 40.5 | 40 | 46 |

45° C.

| | | | | |
|---|---|---|---|---|
| 4 weeks | Stable | Stable | Stable | Stable |
| 8 weeks | Stable | Stable | Stable | Stable |

Note:
pH of all formulations range from 1.6 to 2.

To keep the pH of the antimicrobial composition nearly constant as a means to enhance its stability, buffer solutions, which are aqueous solutions consisting of a mixture of a weak acid and its conjugate base, are used. As shown in Tables 17A, 17B and 18, sodium citrate was added to the composition to improve the solubility of undecylenic acid, by serving as a buffering agent to keep the pH constant, thereby enhances the stability of the antimicrobial composition, even when alcohol (SDA 40B) was only present at a low concentration (20% w/w).

Table 17: Stability of laundry sanitizers containing 2% w/w undecylenic acid and organic acids and salts thereof.

TABLE 17A

| | CRB- | CRB- | CRB- | CRB- | CRB- | CRB- | CRB- |
|---|---|---|---|---|---|---|---|
| | 86- | 86- | 86- | 86- | 86- | 86- | 86- |
| | CAB | CAB | CAB | CAB | CAB | CAB | CAB |
| Ingredient | 54CO | 54B | 54BO | 53B | 53BO | 58 | 58O |
| Undecylenic | 2 | 2 | 2 | 2 | 2 | 2 | 2 |
| acid | | | | | | | |
| Citric acid | 15 | 15 | 15 | 15 | 15 | 15 | 15 |
| SDA 40B | 20 | 20 | 20 | 20 | 20 | 20 | 20 |
| Benzoic acid | 2 | 2 | 2 | 3 | 3 | 3 | 3 |
| SDS | 3 | 3 | 3 | 3 | 3 | 3 | 3 |
| Octanediol | 0.5 | — | 0.5 | — | 0.5 | — | 0.5 |
| Sodium | 1 | 2 | 2 | 1 | 1 | 2 | 2 |
| Citrate | | | | | | | |
| Water | 56 | 56 | 55.5 | 56 | 55.5 | 55 | 54.5 |
| (qs to 100) | | | | | | | |

45° C.

| | | | | | | | |
|---|---|---|---|---|---|---|---|
| 4 weeks | Stable | Stable | Stable | Stable | Stable | Stable | Stable |
| 8 weeks | Stable | Stable | Stable | Stable | Stable | Stable | Stable |
| pH | 2.14 | 2.29 | 2.6 | 2.27 | 2.21 | 2.54 | 2.54 |

TABLE 17B

| | CRB-86 | CRB-86 | CRB-86 | CRB | CRB-86 |
|---|---|---|---|---|---|
| Ingredient | CAB 57 | CAB 57A | CAB 57AO | CAB 53D | CAB 21SC |
| Undecylenic acid | 2.5 | 2.5 | 2.5 | 2.0 | 2.5 |
| Citric acid | 15 | 15 | 15 | 15 | 15 |
| SDA 40B | 20 | 20 | 20 | 20 | 25 |
| Benzoic acid | 2 | 2 | 2 | 3 | 2 |
| SDS | 3 | 3 | 3 | 3 | 3 |
| Octanediol | — | — | 0.5 | — | — |
| Sodium Citrate | 1 | 2 | 2 | — | 2 |
| Potassium Sorbate | — | — | — | 1 | — |
| Water (qs to100) | 56 | 56 | 55 | 56 | 50.5 |

45° C.

| | | | | | |
|---|---|---|---|---|---|
| 4 weeks | Stable | Stable | Stable | Stable | Stable |
| 8 weeks | Stable | Stable | Stable | Stable | Stable |
| pH | 2.2 | 2.51 | 2.3 | 2.1 | 2.35 |

TABLE 18
Propylene glycol improves stability of formulations containing 2% w/w w/w undecylenic acid,
citric acid, sodium citrate, SDS and 15% w/w alcohol (SDA 40B).

| | CRB-86 | CRB-86 | CRB-86 | CRB-86 | CRB-86 | CRB-86 |
|---|---|---|---|---|---|---|
| Ingredient | CAB 59 | CAB 59O | CAB 60 | CAB 60O | CAB 61 | CAB 61O |
| Undecylenic | 2 | 2 | 2.5 | 2 | 2 | 2 |
| acid | | | | | | |
| Citric acid | 15 | 15 | 15 | 15 | 15 | 15 |
| SDA 40B | 15 | 15 | 10. | 10 | 10 | 10 |
| Benzoic acid | 2 | 2 | 2 | 2 | 2 | 2 |
| SDS | 3 | 3 | 3 | 3 | 3 | 3 |
| Sodium Citrate | 2 | 2 | 2 | 2 | 2 | 2 |
| Propylene | 5 | 5 | 10 | 10 | 10 | 10 |
| Glycol | | | | | | |
| Octanediol | — | 0.5 | — | 0.5 | — | 0.5 |
| Water | 56 | 55.5 | 56 | 55.5 | 61 | 60.5 |
| (qs to 100) | | | | | | |

45° C.

| | | | | | | |
|---|---|---|---|---|---|---|
| 4 weeks | Stable | Stable | Stable | Stable | Stable | Stable |
| 8 weeks | Slightly | Stable | Stable | Stable | Stable | Stable |
| | turbid | | | | | |
| pH | 2.24 | 2.35 | 2.26 | 2.3 | 2.3 | 2.3 |

TABLE 19
Formulations containing 2% w/w undecylenic, citric acid, sodium citrate, SDS and
various solvents are stable and effective in killing gram-positive bacteria (e.g., S. aureus).

| | CRB- | CRB- | CRB- | CRB- | CRB- | CRB- | CRB- |
|---|---|---|---|---|---|---|---|
| | 86- | 86- | 86- | 86- | 86- | 86- | 86- |
| | CAB | CAB | CAB | CAB | CAB | CAB | CAB |
| Ingredient | 54CO | 54B | 54BO | 53B | 53BO | 58 | 58O |
| Undecylenic | 2 | 2 | 2 | 2 | 2 | 2 | 2 |
| acid | | | | | | | |
| Citric acid | 15 | 15 | 15 | 15 | 15 | 15 | 15 |
| SDA 40B | 20 | 20 | 20 | 20 | 20 | 20 | 20 |
| Benzoic acid | 2 | 2 | 2 | 3 | 3 | 3 | 3 |
| SDS | 3 | 3 | 3 | 3 | 3 | 3 | 3 |
| Octanediol | 0.5 | — | 0.5 | — | 0.5 | — | 0.5 |
| Sodium Citrate | 1 | 2 | 2 | 1 | 1 | 2 | 2 |
| Water | 56 | 56 | 55.5 | 56 | 55.5 | 55 | 54.5 |
| (qs to 100) | | | | | | | |

45° C.

| | | | | | | | |
|---|---|---|---|---|---|---|---|
| 4 weeks | Stable | Stable | Stable | Stable | Stable | Stable | Stable |
| 8 weeks | Stable | Stable | Stable | Stable | Stable | Stable | Stable |
| pH | 2.14 | 2.29 | 2.6 | 2.27 | 2.21 | 2.54 | 2.54 |
| Log₁₀ | 3.3 | 3 | 3.3 | 3.1 | 3.2 | 3 | 3.3 |
| Reduction | | | | | | | |

The following stable formulations were prepared and tested for antimicrobial efficacy.

Tables 19A-19C:

TABLE 19A

| Ingredient | Range |
|---|---|
| Undecylenic acid | 1.5-2.5 |
| Citric acid | 10-20 |
| SDA 40B | 5-20 |
| Benzoic acid | 1.5-2.5 |
| SDS | 2.5-3.5 |
| Sodium Citrate | 1-3 |
| Propylene Glycol | 5-15 |
| 1,3 Propanediol (Zemea®) | 5-15 |
| Octanediol | 0.25-1 |
| Water (qs to 100) | qs to 100 |
| Total | 100 |

TABLE 19B

| Ingredient | CRB-86-CAB 60O-P |
|---|---|
| Undecylenic acid | 2 |
| Citric acid | 15 |
| SDA 40B | 10 |
| Benzoic acid | 2 |
| SDS | 3 |
| Sodium Citrate | 2 |
| Propylene Glycol | 10 |
| Octanediol | 0.5 |
| Water (qs to 100) | 55.5 |
| Total | 100 |

TABLE 19C

| Ingredient | CRB-86-CAB 60O-Z |
|---|---|
| Undecylenic acid | 2 |
| Citric acid | 15 |
| SDA 40B | 10 |
| Benzoic acid | 2 |
| SDS | 3 |
| Sodium Citrate | 2 |
| Propylene Glycol | 10 |
| Octanediol | 0.5 |
| Water (qs to 100) | 55.5 |
| Total | 100 |

Antimicrobial Efficacy Testing of Formulations

Evaluation of bactericidal efficacy testing in both clean and dirty conditions by EN1276 method SOP M/V 080/8 (the European Standard for Standard tests were conducted with inoculum concentration of 5×10⁸ CFU/mL. The test sample (or blend) was diluted to 1:173 with EN Hard Water prior to all testing.

The tests were carried out with a 5 minute contact time and appropriate neutralization steps in accordance with EN1276 method. Results were reported as log₁₀ reduction from control, shown in Table 19D.

TABLE 19D

| | Clean Condition | Dirty Condition |
|---|---|---|
| S. aureus | 5.6 | 5.6 |
| E. coli | 5.6 | 5.6 |
| P. aeruginosa | 5.6 | 5.6 |
| Entero. Hirae | 5.6 | 5.6 |
| K. pneumoniae | 5.6 | 5.6 |

Conclusion: The above formulations showed more than 5.0 log reduction against all the bacteria tested and passed the EN1276 test

### EXAMPLE 4

### Determination of Antimicrobial Efficacy Using ASTM E2274-16

The antimicrobial efficacy of the stable laundry sanitizers were tested using ASTM E2274-16 Standard Test Method for Evaluation of Laundry Sanitizers and Disinfectants (current edition approved Apr. 15, 2016).

The ASTM E2274.16 test method is a laboratory model that is commonly adopted by the US EPA for testing chemicals agents to determine both the efficacy of said agents as laundry disinfectants or sanitizers and residual bacteriostatic effects on finished fabrics. This test method is flexible enough to accommodate many of the variables encountered in different laundry processes.

To carry out the ASTM E2274-16 test method, sets of inoculated fabric swatches are placed in diluted product solution and agitated, under simulated laundry conditions. After a specific contact time, the wash water and the test fabric are individually cultured either quantitatively to determine sanitizer efficacy or qualitatively to determine disinfectant efficacy.

Specific study conditions were: Test group dilution 1:173 in AOAC ˜400 ppm Hard Water, Clean conditions with contact time: 16 mins.

Test Groups:

TABLE 20

| Ingredient | |
|---|---|
| | CRB-86-CAB-20 |
| Undecylenic acid | 2 |
| Citric acid | 15 |
| Denatured alcohol | 20 |
| Benzoic acid | 2 |
| Sodium dodecyl sulfate | 3 |
| Water | 58 |
| Total | 100 |
| | CRB-86-CAB-21 |
| Undecylenic acid | 2.5 |
| Citric acid | 15 |
| Denatured alcohol | 25 |
| Benzoic acid | 2 |
| Sodium dodecyl sulfate | 3 |
| Water | 52.5 |
| Total | 100 |

As shown in Table 21, both groups tested (CRB-86-CAB-20 and CRB-86-CAB-21) passed the ASTM E2274-16 test with >3.0 log₁₀ reductions for wash water and swatch in both pathogens tested, namely, Staphylococcus aureus and Klebsiella pneumonia.

TABLE 21

| | Staphylococcus | | Klebsiella | |
|---|---|---|---|---|
| Sample | aureus | | pneumoniae | |
| Information | Log₁₀ Reduction | Result | Log₁₀ Reduction | Result |
| CRB-86-CAB-20 | Swatch | Pass | Swatch | Pass |
| | 5.09 | | 4.34 | |
| | Wash Water | | Wash Water | |
| | 3.16 | | 3.91 | |
| CRB-86-CAB-21 | Swatch | Pass | Swatch | Pass |
| | 5.09 | | 4.48 | |
| | Wash Water | | Wash Water | |
| | 3.16 | | 3.91 | |

Although the present invention has been described in relation to embodiments thereof, these embodiments and examples are merely exemplary and not intended to be limiting. Many other variations and modifications and other uses will become apparent to those skilled in the art. The present invention should, therefore, not be limited by the specific disclosure herein, and can be embodied in other forms not explicitly described here, without departing from the spirit thereof.

1. A stable botanical antimicrobial composition comprising:
(a) 1 to 7% undecylenic acid;
(b) 1 to 20% w/w organic acid or salt thereof; wherein the organic acid is citric acid, lactic acid, benzoic acid, sorbic acid, salicylic acid, or any combination thereof; and
(c) 10 to 40% w/w ethanol or denatured alcohol.

2. The composition of claim 1, further comprising 0.5 to more surfactants selected from sodium dodecyl sulfate, potassium dodecyl sulfate, a nonionic surfactant, or any combination thereof.

3. The composition of claim 1, further comprising one or more solubility enhancing agents selected from pentylene glycol, octanediol, decanediol, 1,3 propanediol, propylene glycol, glycerin, benzyl alcohol, phenoxyethanol, phenyl ethanol, isopropanol, or any combination thereof.

4. The composition of claim 1, further comprising one or more chelating agents selected from sodium EDTA, sodium phytate or any combination thereof.

5. The composition of claim 1, further comprising 0.1 to 5% w/w one or more essential oils or ingredients thereof selected from lemongrass oil, lemon oil, orange oil, cinnamon oil, cedarwood oil, myrrh oil, geranium oil, bergamot oil, thymol, farnesol, or any combination thereof.

6. An antimicrobial composition comprising:
(a) 1 to 3% w/w undecylenic acid;
(b) 12 to 18% w/w citric acid;
(c) 10 to 40% w/w alcohol;
(d) 1 to 5% w/w benzoic acid;
(e) 1 to 3% w/w sodium citrate;
(f) 2 to 4% w/w sodium dodecyl sulfate;
(g) 0.3 to 1% w/w octanediol;
(h) 5 to 10% w/w co-solvent selected from: (i) propyleneglycol, (ii) 1,3 propanediol, or any combination thereof; and
(i) 40 to 60% w/w water.

7. The composition obtained when the composition of claim 1 is diluted with water from 1:10 to 1:1200.

8. The composition of claim 7 diluted with water from 1:200.

9. The composition of claim 1, wherein the composition is a laundry sanitizer.

10. A method of sanitizing or disinfecting laundry or a fabric, the method comprising contacting the composition of claim 1 with the laundry or fabric.

11. The method of claim 10, comprising adding the composition to a washing machine.

12. The method of claim 11, wherein the composition is added in a rinse cycle.

13. The method of claim 11, wherein the composition is added at the same time as a laundry detergent in a washing cycle.

14. The method of claim 11, wherein the washing machine is an automatic laundering machine, and wherein the composition is added in a laundry detergent composition compartment in said automatic laundering machine and released during a main wash cycle.

15. The method of claim 10, wherein the composition achieves at least 5.0 log₁₀ reduction in bacterial growth from that of control in the EN1276 test when challenged with 5×10⁸ CFU of bacteria, within 5 minutes of contact.
